(19) United States
(12) Patent Application Publication
(10) Pub. No.: US 2010/0239337 A1
(43) Pub. Date: Sep. 23, 2010

(54) Fixing device and image forming apparatus incorporating same

(75) Inventors: Satoshi Muramatsu, Yokohama-shi (JP); Kunihiko Tomita, Yokohama-shi (JP)

Correspondence Address: HARNESS, DICKEY & PIERCE, P.L.C., P.O. BOX 8910, RESTON, VA, 20195, US

(73) Assignee: Ricoh Company, Ltd.

(21) Appl. No.: 12/659,606

(22) Filed: Mar. 15, 2010

(30) Foreign Application Priority Data
Mar. 17, 2009 (JP) 2009-063783

(51) Int. Cl. G03G 15/20

(52) U.S. Cl. 399/329

(57) ABSTRACT

A belt-fixing device includes a first seamless belt, a second seamless belt disposed in contact with the first belt to form a nip, a heating member, a first roller disposed inside the first belt, a second roller disposed inside the first endless belt upstream from the first roller in a direction in which the recording medium is conveyed, a third roller disposed inside the second belt, facing the first roller, to cause the first belt and the second belt to press against each other at the nip, and a fourth roller disposed inside the second belt, facing the second roller to cause the first belt and the second belt to press against each other at the nip. The second roller rotates at a peripheral velocity different from that of the first roller and the fourth roller rotates at a peripheral velocity different from that of the third roller.

### CROSS-REFERENCE TO RELATED APPLICATIONS

This patent specification claims priority from Japanese Patent Application No. 2009-063783, filed on Mar. 17, 2009 in the Japan Patent Office, which is hereby incorporated by reference herein in its entirety.

### BACKGROUND OF THE INVENTION

1. Field of the Invention

The present invention relates to a fixing device to fix images on recording media, and an image forming apparatus, such as a printer, facsimile machine, copier, plotter, or multi-functional peripheral, employing the fixing device.

2. Discussion of the Background

Rendering visible image data using latent images formed using image forming apparatuses employing electrophotographic or electrostatic recording methods is used in a wide variety of fields.

For example, in the electrophotographic method, a latent image is formed on a photoreceptor according to image data by executing a charging process and an exposure process and then is developed with developer (e.g., toner) into a visible image, after which the image is recorded on a recording medium, such as a sheet of paper, by executing a transfer process and a fixing process.

In image forming apparatuses, such as printers, facsimile machines, copiers, plotters, or multi-functional peripherals having several of the foregoing functions, an unfixed image transferred onto the sheet is fixed thereon in the fixing process, and then the sheet is discharged as a printing output. Each of the image forming apparatuses includes a fixing device to execute the fixing process.

Certain known fixing devices include a pair of rollers facing each other that function as a heating member and a pressing member, respectively. Both rollers are disposed pressing against each other to form a fixing nip through which the sheet of recording medium is passed. In this fixing device, when the sheet passes between the fixing member and the pressing member, the image is fixed on the sheet with heat and pressure by fusing unfixed image. Alternatively, in other fixing devices, multiple belts press against each other to form the fixing nip, similarly to the above-described configuration.

In general, in order to obtain glossy image, the extent of contact of the toner image when present between a fixing roller and a pressure member (e.g., rubber roller) to be heated (hereinafter “nip contact”) must be sufficient. In order to secure the needed nip contact, the size of the contact area between the heating member and rubber roller in the sheet conveyance direction, that is, a contact width or nip width, should be sufficiently large.

Therefore, for example, in one conventional approach, a sufficient contact width between the heating member and a rubber roller, that is, nip width, is maintained by buckling the rubber roller toward the fixing roller by deformation of the rubber, for example. Increasing flexibility and decreasing thickness of the rubber layer of the rubber roller can facilitate deformation of the rubber roller, increasing the contact area between the fixing roller and the rubber roller. However, although the pressing force can be enhanced by softening the rubber, there is a limit to the degree of softness of the rubber and the extent of the pressing force. Moreover, if the rubber is excessively soft, maintaining the shape of the rubber roller is difficult, and if the pressing force is excessively strong, the roller can be bent.

Another conventional approach uses a sponge roller instead of the rubber roller described above. In this approach, although, the pressing force becomes adequate and the nip width can be increased by using very soft rubber, the useful life of the sponge is relatively short and brittle fractures appear in the sponge after the sponge is repeatedly compressed and expanded.

In view of the foregoing, several approaches described below have been proposed to secure a sufficient nip contact. For example, certain known fixing devices employ a fixing roller and an endless fixing belt pressed against the fixing roller. In this configuration, the fixing belt partly follows the arc of the fixing roller, and the nip contact is lengthened.

Yet another known fixing device includes a first fixing roller, a second fixing roller disposed facing the first fixing roller, a conveyance roller disposed at a predetermined distance from the first fixing roller, a heater attached to at least one of the fixing rollers, and an endless belt wound around the first fixing roller and the conveyance roller. In this configuration, when the sheet (transfer material) on which an unfixed toner image is formed passes between the endless belt and the second fixing roller, the toner image is fixed on the sheet with heat and pressure.

This fixing device uses a metal substrate for the endless belt or further includes a charging device disposed adjacent to an entrance guide to apply a relatively high pressure and a relatively high charge to the transfer material. Although this configuration uses a single belt and only one side of the sheet on which the toner is transferred contacts the belt, fixing devices including multiple belts pressing against each other have been proposed because length of the nip formed by two belts closely contacting each other can be as long as a perimeter of the belts permits, and the nip contact can be lengthened.

For example, one known fixing device (image heating device) includes a fixing belt wound around at least a fixing roller as well as a first elastic pad, a pressing belt wound around at least a pressing roller as well as a second elastic pad, and a heating member. The pressing roller is disposed facing the fixing roller. The second elastic pad is disposed facing the first elastic pad and both elastic pads presses against each other to press the fixing belt and the pressing belt. Thus, a fixing nip is formed by the rollers and the elastic pads. The heating member heats the fixing belt to heat image on the sheet at the fixing nip.

In this fixing device, because pressure dispersion in a center portion of the fixing belt and the pressing belt in width direction at an entrance of the fixing nip is larger than that at both end-edges, the sheet can be prevented from wrinkling in the image heating device.

However, in this example, when the two belts are rotated, the fixing roller and the pressing roller tend to slide on an inner surface of the respective the fixing belt and the pressing belt, and the fixing belt rotated by the pressing belt also tends to slide on the pressing belt. In particular, when the image is sandwiched in the fixing nip, because the fixing belt does not contact the pressing belt, the fixing belt can drastically slide on the pressing belt. Therefore, a difference in peripheral velocity between the fixing belt and the pressing belt is generated, which can cause the image to be misaligned or out of position.

Additionally, in this configuration, because the multiple belts are relatively thin, the respective thin belts are biased as the belts rotate. In particular, when the belts vibrate in the circumferential direction, the nip pressure fluctuates, therefore the sheets may get wrinkled and image misalignment may occur, which can be a serious problem.

In order to solve this problem, in one example, a cylindrical belt guide member is disposed extending along an entire inner surface of one of the two belts pressing against each other, and elastic rollers are provided in the facing portion of the cylindrical belt guide member. However, in this configuration, because the cylindrical belt guide member increases heat capacity, the heat efficiency is reduced. Additionally, when a distance between the periphery of the cylindrical belt guide member and the inner surface of the belt is close to zero, friction therebetween is increased, and attrition of the belt may occur. Therefore, a predetermined distance should be kept therebetween. Namely, this means that a margin of the belt is required. However, in this example, the margin of the belt is biased to an exit side by inertial force of the belt at a nip exit, thereby vibrating the belt.

Accordingly, there is a need for a technology to prevent the sheet from wrinkling and image from deviating caused by vibration of the belt in a circumferential direction in the fixing device including multiple belts.

### SUMMARY

In view of the foregoing, one illustrative embodiment of the present invention provides a belt-fixing device that includes a first belt, a second belt, a heating member, a first roller, a second roller, a third roller, and a fourth roller. The first belt is formed of a seamless belt. The second belt that is formed of a seamless belt is disposed in contact with the first belt and forms a nip through which a recording medium passes with the first belt. The heating member heats at least one of the first belt and the second belt. The first roller is disposed inside the first belt. The second roller that is disposed inside the first endless belt, upstream from the first roller in a direction in which the recording medium is conveyed rotates at a peripheral velocity different from a peripheral velocity of the first roller. The third roller that is disposed inside the second belt, facing the first roller causes the first belt and the second belt pressing against each other at the nip. The fourth roller that is disposed inside the second belt, facing the second roller causes the first belt and the second belt pressing against each other at the nip and rotates at a peripheral velocity different from a peripheral velocity of the third roller.

Another illustrative embodiment of the present invention provides an image forming apparatus that includes an image carrier, a charging device to charge the image carrier uniformly, an exposure device to expose the charged surface of the image carrier, forming a latent image on the image carrier, a developing device to visualize the latent image formed on the surface of the image carrier, a cleaning device to remove residual toner on the image carrier, a transfer device to transfer the visualized image onto a recording medium directly or indirectly via an intermediate transfer member, and the belt-fixing device described above to fix the image on a recording medium.

### BRIEF DESCRIPTION OF THE DRAWINGS

A more complete appreciation of the disclosure and many of the attendant advantage thereof will be readily obtained as the same becomes better understood by reference to the following detailed description when considered in connection with the accompanying drawings, wherein:

FIG. 1 is an overall schematic view illustrating a configuration of an image forming apparatus including a belt-fixing device according to one illustrative embodiment of the present invention;

FIG. 2 is a cross-sectional diagram illustrating a configuration of the belt-fixing device shown in FIG. 1;

FIG. 3 is a perspective view illustrating the belt-fixing device shown in FIG. 2 entirely;

FIG. 4 is a schematic diagram illustrating a configuration of a driving mechanism viewed from a back side of the belt-fixing device shown in FIG. 2; and

FIG. 5 is a schematic diagram illustrating a configuration of another driving mechanism according to a variation of the belt-fixing device shown in FIG. 2.

### DETAILED DESCRIPTION OF PREFERRED EMBODIMENTS

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve a similar result.

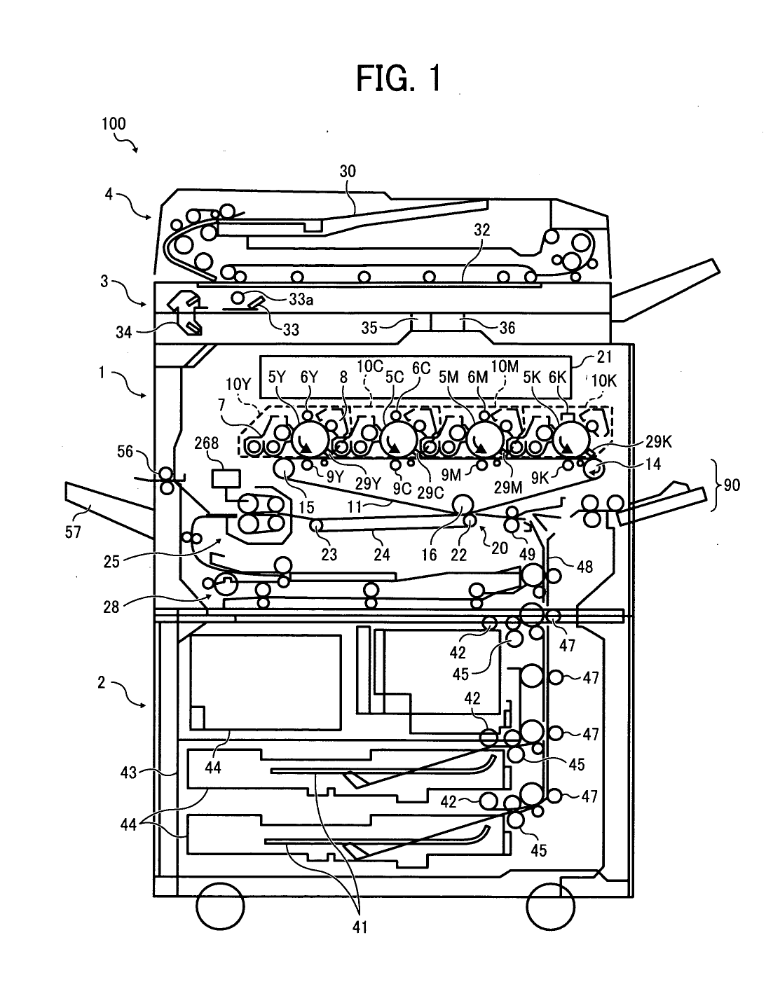

Referring now to the drawings, wherein like reference numerals designate identical or corresponding parts throughout the several views thereof, particularly to FIG. 1, an image forming apparatus according to an example embodiment of the present invention is described below. It is to be noted that although the image forming apparatus of the present embodiment is a printer, the image forming apparatus of the present invention is not limited thereto.

(Image Forming Apparatus)

FIG. 1 is a schematic diagram illustrating a configuration of an image forming apparatus 100 that in the present embodiment is a multicolor image forming apparatus.

The multicolor image forming apparatus 100 is a tandem-type electrophotographic device including an intermediate transfer belt 11.

In FIG. 1, an automatic document feeder (ADF) 4, a scanner 3, and an image forming body 1 are stacked on a feed unit 2. The image forming apparatus 100 forms images through a latent image forming process, a developing process, a transfer process, a cleaning process, and a fixing process, executed in that order. A configuration of the image forming body 1 is described below.

In a center portion of the image forming body 1, a primary transfer device 90 including the intermediate transfer belt 11 is disposed. The primary transfer device 90 further includes four primary transfer members 9Y, 9M, 9C, and 9K, a driving roller 14, driven rollers 15 and 16, and a belt-cleaning device (not shown).

The intermediate transfer belt 11, which is a seamless (endless) belt, is wound around and is rotated by the driving roller 14 and the driven rollers 15 and 16. The belt-cleaning device (not shown) disposed on the left of the driven roller 15 removes residual toner adhering to the intermediate transfer belt 11 to prepare the intermediate transfer belt 11 for a next image forming process.

Above the primary transfer device 90, four image forming units 10Y, 10M, 10C, and 10K are disposed. It is to be noted that, in the image forming device 300, reference character suffixes Y, M, C, and K attached to identical reference numerals indicate only that components indicated thereby are used for forming different single-color images, respectively, and hereinafter may be omitted when color discrimination is not necessary. Each image forming unit 10 includes a photoreceptor 5, a charging member 6, a developing device 7, a photoreceptor-cleaning blade 8, and an image density detector 29. The photoreceptors 5Y, 5C, 5M and 5K are rotatably disposed along the intermediate transfer belt 11. The developing devices 7, the charging device 6, the photoreceptor cleaner 6, and the image density detector 29 are disposed adjacent to the photoreceptors 5.

The developing device 7 develops an electrostatic latent image formed on the photoreceptor 5 with toner into a single-color toner image in the developing process. Although not depicted in the drawings, a discharging device and a lubrication coating device are disposed in the image forming unit 10 to assist in this process.

Above the image forming units 10, an exposure device 21, which includes a laser light source, is disposed. The exposure device 21 executes an electrostatic latent image forming process to form electrostatic latent images on the respective photoreceptors 5.

Beneath the primary transfer unit 90, a secondary transfer unit 20 that includes a secondary transfer member 22, a roller 23, and a conveyance belt 24 is provided. The secondary transfer member 22 is located beneath the intermediate transfer belt 11 to press against the driven roller 16 via the intermediate transfer belt 11. The secondary transfer member 22 collectively transfers single-color toner images superimposed one on another on the intermediate transfer belt 11 onto a sheet P, serving as a recording medium, conveyed between the secondary transfer member 22 and the intermediate transfer belt 11. It is to be noted that a transfer roller or a transfer member using a contactless type charger can be used as the secondary transfer member 22.

Thus, the primary transfer unit 90 and the secondary transfer unit 20 sandwiching the intermediate transfer belt 11 execute transfer processes.

Further, a belt-fixing device 25 is provided downstream from the secondary transfer device 22 in a direction in which the sheet P is conveyed (hereinafter “sheet conveyance direction”). The sheet P onto which the image is transferred is conveyed to the belt-fixing device 25 by the seamless conveyance belt 24 bridged between the secondary transfer member 22 and the roller 23. The belt-fixing device 25 fixes an image on the sheet P with heat and pressure, which is described in further detail later.

Further, a sheet reverse mechanism 28 that reverses the sheet P to form images on both sides of the sheet P in duplex printing is provided downstream from the belt-fixing device 25 in the sheet conveyance direction.

Moreover, a pair of discharge rollers 56 and a discharge tray 57 are disposed on a discharge side of the image forming body 1.

Basic operation of the image forming apparatus 100 is described below with reference to FIG. 1.

As sheet feeding modes, the image forming apparatus 100 has a normal mode and a manual feeding mode. When a user makes copies of a document D using the image forming apparatus 100, initially, in the normal mode, the user sets a document D on a document table 30 of the ADF 4. Alternatively, in the manual feeding mode, the user opens the ADF 4, sets the document D on a contact glass 32 of the scanner 3 disposed beneath the ADF 4, and then presses the document D with the contact glass 32 by closing the ADF 4.

Subsequently, when a start switch (not shown) is pushed in the normal mode, the document D is conveyed automatically to the contact glass 32, and then the scanner 3 is activated. Alternatively, in the manual feeding mode, the scanner 3 is immediately activated after the start switch is pushed. When the scanner 3 is activated, a first carriage 33 and a second carriage 34 begin moving. Therefore, a light source 37 disposed adjacent to the first carriage 33 emits a laser light onto the document D, and a pair of mirrors in the second carriage 34 turns a direction in which the ray of light travels 180 degrees. Then, the ray of light passes though an imaging lens 35 and enters a reading sensor 36, and the contents of the document D are read by the reading sensor 36.

Along with these processes, when the start switch is pushed, the photoreceptor 5Y, 5M, 5C, and 5K are rotated, timed to condense with the rotation of the intermediate transfer belt 11, and single-color toner images are formed on the respective photoreceptors 5. Then, the respective single-color toner images are superimposed one on another on the intermediate transfer belt 11 that rotates clockwise in FIG. 1, and thus a superimposed multicolor toner image is formed thereon.

Additionally, along with these processes, a feed roller 42 of a selected rack of the feed unit 2 rotates, and sheets P are fed out from a selected feed tray 44 in a feed unit 43 one by one from the top, separated by a separation roller 45. Then, the sheet P thus fed is conveyed, guided by a conveyance guide 48, to the image forming body 1 by multiple conveyance rollers 47 and is stopped by a pair of registration rollers 49.

Subsequently, timed to coincide with the arrival of the multicolor-toner image on the intermediate transfer belt 11, the pair of registration rollers 49 starts rotating to convey the sheet P between the intermediate transfer belt 11 and the secondary transfer member 22. Then, the multicolor-toner image is transferred onto the sheet P by the secondary transfer member 22.

Subsequently, the sheet P carrying a multicolor-toner image thereon is conveyed to the belt-fixing device 25 by the conveyance belt 24 in the secondary transfer device 20, and the belt-fixing device 25 executes a fixing process to fix the multicolor-toner image on the sheet P with heat and pressure.

Thereafter, the sheet P is guided toward the discharge side of the image forming apparatus and is discharged to the discharge tray 57 by the discharge roller 56.

Alternatively, when duplex printing to record images on both sides of the sheet is selected, after the image is formed on one side of the sheet P, the transfer-sheet P is fed to the sheet reverse mechanism 28. The sheet P thus reversed is conveyed to a position facing the secondary transfer member 22 so as to form an image on the other side of the sheet P, and then the sheet P is discharged to the discharge tray 57 by the discharge roller 56.

Herein, when monochrome images (black image) are formed on the intermediate transfer belt 11, the driven rollers 15 and 16 are moved but the driving roller 14 is not, and the photoreceptors 5Y, 5C, 5M for the yellow, cyan, and magenta are separated from the intermediate transfer belt 11. Additionally, if an image forming apparatus that is not a tandem-type apparatus as shown in FIG. 1 but is a one-drum type and includes only a single photoreceptor drum is used, generally, a black image is initially formed so as to increase the first copy speed, after which other color images are formed when multicolor images are formed.

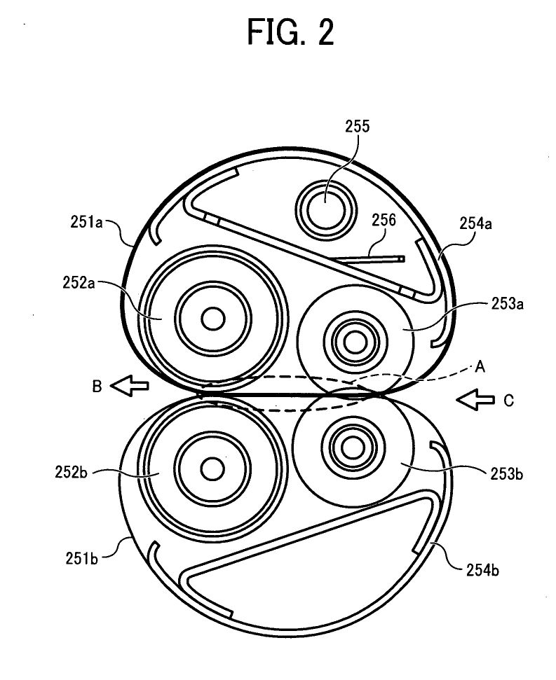

FIG. 2 is a cross-sectional diagram illustrating a configuration of the belt-fixing device 25 according to the present embodiment.

As shown in FIG. 2, the belt-fixing device 25 includes two seamless belts, a first belt 251a and a second belt 251b, that are disposed in contact with each other, and a contact area therebetween is hereinafter referred to as “nip A”. A first nip-roller 252a and a first guide-roller 253a are disposed inside the first belt 251a, and a second nip-roller 252b and a second guide-roller 253b are disposed inside the second belt 251b. The first nip-roller 252a and the first guide-roller 253a are disposed facing the second nip-roller 252b and the second guide-roller 253b, respectively, pressing the first belt 251a and the second belts 251b at the nip A against each other.

A predetermined pressure is exerted between an axis of the first nip-roller 252a and an axis of the second nip-roller 252b by a pressing member (not shown) such as a compression spring. The first nip-roller 252a is rotated by a driving source 268 (shown in FIG. 1) of a driving mechanism 26 via a gear mechanism 264 (shown in FIG. 4). Further, the first nip-roller 252a and the second nip-roller 252b are formed of a metal core and a rubber layer surrounding the metal core.

Additionally, the first guide-roller 253a is located upstream from the first nip-roller 252a in the sheet conveyance direction inside the first belt 251a, and the second guide-roller 253b is located upstream from the second nip-roller 252b in the sheet conveyance direction inside the second belt 251b Therefore, in an area where the sheet is conveyed linearly, the rollers 252a, 252b, 253a, 253b function as support members to form the nip A, that is, the contact area between the first belt 251a and the second belt 251b. A predetermined pressure is exerted between an axis of the first guide-roller 253a and an axis of the second guide-roller 253b by a pressing member (not shown) such as a compression spring. In this configuration, the first nip-roller 252a serves as a first-roller, the first guide-roller 253a serves as a second roller, the second nip-roller 252b serves as a third roller, and the second guide-roller 253b serves as a fourth roller.

Further, the first guide-roller 253a and the second guide-roller 253b are formed of a metal core and an elastic material, such as rubber or sponge rubber, surrounding the metal core. Thus, a certain degree of nip pressure is generated in the nip A by repulsion force of the cylindrical first belt 251a and second belt 251b attempting to revert to a cylindrical shape.

Additionally, a halogen heater 255 and a reflection plate 256 are provided inside the first-belt 251a, thereby intensively heating an upper side of the first belt 251a from inside. Such a configuration dramatically reduces heat leakage, thus improving heating efficiency.

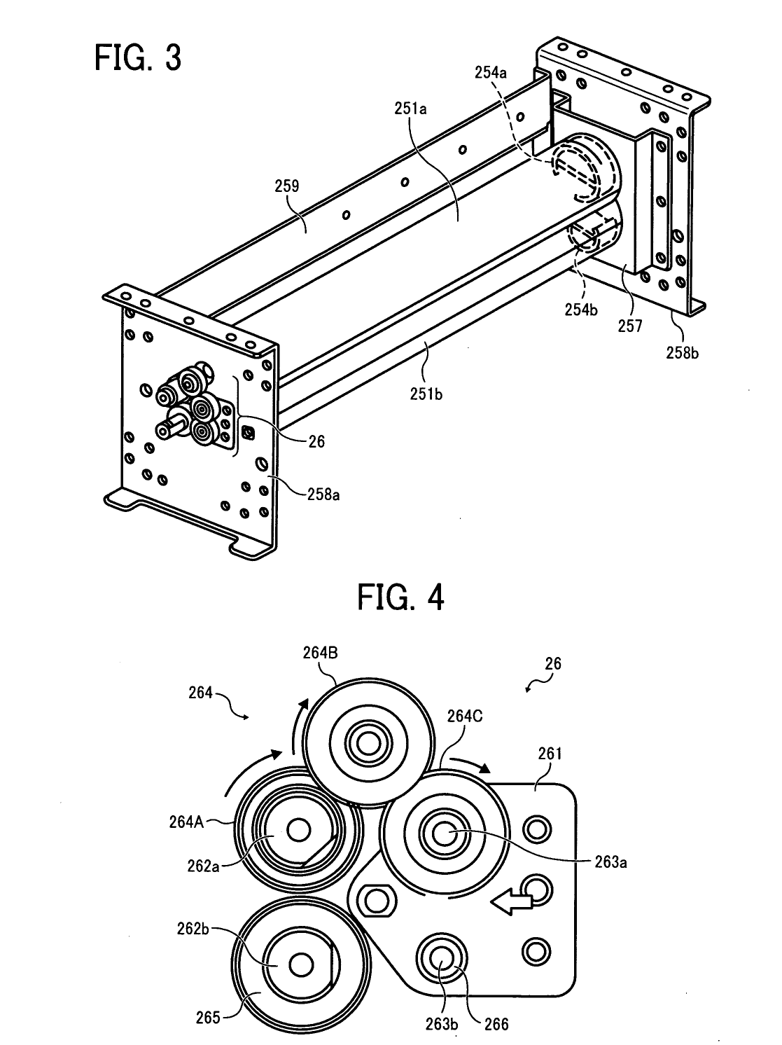

FIG. 3 is a perspective view illustrating the belt-fixing device 25 as a whole. As shown in FIG. 3, the belt-fixing device 25 further includes a front side board 258a, a back side board 258b, the driving mechanism 26 disposed on the front side board 258a, a stay 259 extending between the front side board 258a, and the back side board 258b parallel to the first belt 251a, and a pair of wrinkle prevention plates 257.

As the driving mechanism 26 drives the first nip-roller 252a, the first belt 251a rotates, which rotates the first guide-roller 253a, the second belt 252b, the second nip-roller 252b, and the second guide-roller 253b. The driving mechanism 26 and both ends of the first belt 251a and the second belt 251b are supported by respective bearing assemblies provided on the front side board 258a and the back side board 258b

In general, in order to obtain glossy image, the extent of contact of the toner image when present between a fixing roller and a pressure member (e.g., rubber roller) to be heated (hereinafter “nip contact”) must be sufficient. In order to secure the needed nip contact, the size of the contact area between the heating member and rubber roller in the sheet conveyance direction, that is, a contact width or nip width, should be sufficiently large.

In the present embodiment, the length (width) of the nip A sandwiched by the multiple belts can be as long as a perimeter of the belts permits. Therefore, glossy images can be obtained in the fixing process.

Herein, the belt-fixing device 25 depicted in FIG. 2 further includes a first guide-member 254a disposed inside the first belt 251a and a second guide-member 254b disposed inside the second belt 251b. The first guide-member 254a and the second guide-member 254b function as a guide mechanism to prevent the first belt 251a and the second belt 252b from leaning to one side and to promote rotation of the belts. Additionally, the first guide-member 254a and the second guide-member 254b can make the nip A longer. Then, a certain degree of nip pressure is generated in the nip A by repulsion force of the cylindrical first belt 251a and second belt 251b attempting to revert to a cylindrical shape.

As shown in FIG. 2, the first guide-member 254a extends along almost the entire circumference of the first belt 251a except a portion around the nip A, and the second guide-member 254b extends along almost the entire circumference of the second belt 251b except a portion around the nip A.

In a longitudinal direction of the belt-fixing device 25 perpendicular to the sheet conveyance direction, the first guide-member 254a and the second guide-member 254b are disposed only in end portions on both sides shown in FIG. 3 where the sheet P does not contact (non-image portion) to minimize sliding resistance between the guide-members 254 and the belts 251 as well as heat capacity of the belt-fixing device 25. Therefore, vibration of the first belt 251a and the second belt 251b can be prevented or reduced.

Additionally, when the belt-fixing device 25 according to the present embodiment is used in an image forming apparatus such as a copier, a favorable nip A can be easily formed. Therefore, expanding the roller fixing device to increase the nip width is not required, and the cost can be reduced. Moreover, load on the end portions of the belt can be reduced, thus doubling the life of the belt over that of the belt in comparative examples.

FIG. 4 is a schematic diagram illustrating a configuration of the driving mechanism 26 viewed from a back side of the belt-fixing device 25 according to the present embodiment.

In the present embodiments, the first belt 251a and the second belt 251b are driven by driving the first nip-roller 252a and the second nip-roller 252b. The first nip-roller 252a is driven by a driving source 27 (shown in FIG. 1) via a first nip-gear 264A. The second nip-roller 252b is rotated together with the first nip-roller 252a by sliding of the first belt 251a and the second belt 251b, and the second nip-roller 252b is rotated at same velocity as the first nip-roller 252a.

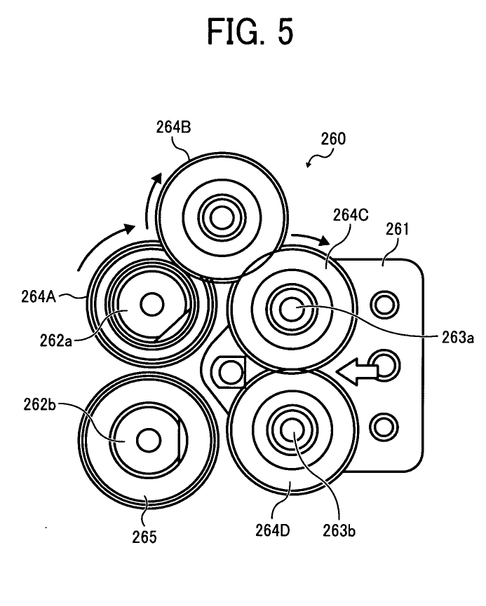

In the configurations shown in FIGS. 4 and 5, the belt-fixing device 25 does not include a gear to transmit the driving force from the first nip-roller 252a to the second nip-roller 252b. Alternatively, the second nip roller 252b may be rotated by rotation of the first nip-roller 252a via the first belt 251a and the second belt 251b. If the perimeter of the rollers and degree by which the rubber is squashed are identical in the two rollers, both rollers may be rotated at the same velocity via a gear. However, actually, the perimeters slightly differ between the two rollers because of tolerance and variation in manufacturing process, and accordingly, using the gear to transmit the driving force in the first nip-roller 252a to the second nip-roller 252b may cause deviation therebetween in the velocity. Therefore, rotation of the first nip-roller 252b accompanied by the first nip-roller 252a is preferable for rotating the two rollers at the same velocity. Additionally, in this embodiment, the second guide-roller 253b is rotated by rotation of the first guide-roller 253a via the first belt 251a and the second belt 251b.

Next, vibration of the belts is described below with reference to FIG. 2.

The nip A is almost linear as shown in FIG. 2, and, when the first belt 251a and the second belt 251b are driven, the exit of the nip A receives a pressing force in a direction indicated by arrow B shown in FIG. 2 by inertial force of the nip A, and the first belt 251a and the second belt 251b, except the portions around the nip A, try to move in the direction indicated by arrow B. However, restorative force becomes relatively strong when the first belt 251a and the second belt 251b are deformed to a certain degree. In other words, at this time, the force is exerted in a direction opposite the direction indicated by arrow B.

Therefore, the first belt 251a and the second belt 251b are vibrated by fluctuation in the balance between the force in the direction indicated by arrow B and the force in the opposite direction. When the first belt 251a and the second belt 251b vibrate, the inner circumferential surfaces of the first belt 251a and the second belt 251b slide on the respective surfaces of respective first guide-member 254a and second guide-member 254b. Thus, attrition of the belt, the torque, and/or noise all increase.

Therefore, the surfaces of the first guide-member 254a and the second guide-member 254b are coated with a slippery material, such as Teflon (registered trademark), to reduce vibration of the belt.

It is to be noted that, hereinafter, the first nip-roller 252a and the second nip-roller 252b disposed downstream in the sheet conveyance direction in the nip A are simply referred to as nip-rollers 252 collectively when discrimination therebetween is not necessary, and the first guide-roller 253a and the second guide-roller 253b disposed upstream in the sheet conveyance direction in the nip A are simply referred to as guide-rollers 253 collectively when discrimination therebetween is not necessary.

A characteristic feature of the present embodiment is that the peripheral velocity of the nip-rollers 252 differs from that of the guide-rollers 253 to weaken the force acting in nip A in the direction opposite the force in the direction indicated by arrow B. Effects of varying the peripheral velocity of the nip-rollers 252 from that of the guide-rollers 253 is described below.

Referring to FIG. 2, when the sheet P onto which an unfixed image is transferred passes through the nip A in a direction indicated by arrow C shown in FIG. 2, the first belt 251a contacts the image face of the sheet P, and the toner on the sheet P is heated.

Herein, when the first belt 251a or the second belt 251b loosens or gaps are created between them in the nip A, that is, the first belt 251a and the second belt 251b are not sufficiently in contact with each other, the toner cannot be heated adequately, and therefore, image failures, such as, image misalignment, gloss shortage, and/or white void, occur. In order to absorb the force that is exerted in the direction opposite the direction indicated by arrow B (hereinafter “opposite force”), the peripheral velocity (peripheral linear velocity) of the guide-rollers 253 is slower than that of the nip-rollers 252. Accordingly, tensile force of the first belt 251a in the fixing nip A can be stable, thereby enhancing the contact force between the first belt 251a and the second belt 252b. Therefore, in the belt-fixing device 25 in the present embodiment, the image failures, such as, image misalignment, gloss shortage, and white void, can be prevented.

In this configuration, the peripheral velocity of the guide-rollers 253 is slower than the peripheral velocity of the nip-rollers 252, and conversely, the velocity of the nip-rollers 252 is faster than that of the guide-rollers 253. As a result, the opposite force is offset.

Herein, with reference to FIG. 4, the gear mechanism 26 in the belt-fixing device 25 includes a guide-roller positioning plate 261, the first nip-gear 264A, an idler gear 264B, a first guide-gear 264C, a shaft bearing assembly 265, and a shaft bearing assembly 265. The shaft bearing assembly 265 receives a shaft 262b of the second nip-roller 252b. The shaft bearing assembly 266 receives a shaft 263b of the second guide-roller 253b. The first nip-gear 264A that is attached to a shaft 262a of the first nip-roller 252a engages the first guide-gear 264C that is attached to a shaft 263a of the first guide-roller 253a via an idler gear 264B, and the rotation of the first nip-roller 252a is transmitted to the first guide-roller 253a. The first nip-gear 264A serves as a first gear, the first guide-gear 264C serves as a second gear.

Each of the gears 264A, 264B, and 264C, which are circular in shape, has a set of teeth. The first nip-gear 264A has 33 teeth, the idler gear 264B has 20 teeth, and the first guide-gear 264C has 20 teeth as well. Additionally, for example, an outer diameter of the first nip-roller 252a is 20 mm, and an outer diameter of the first guide-roller 253a is 12 mm. Therefore, the ratio of peripheral velocity of the first guide-roller 253a to the first nip-roller 252a is (33/20)×(12/20)=0.98 (98%). Thus, the velocity of the first guide-roller 253a can be slower by 2% than the velocity of the first nip-roller 252a.

As described above, in the present embodiment, it is preferred that the peripheral velocity of the guide-rollers 253 is slower by 1% to 2% than the peripheral velocity of the nip-rollers 252. When the difference in peripheral velocity between the nip-rollers 252 and the guide-rollers 253 is smaller than 1%, the effect to offset the opposite force is relatively small. Therefore, the contact between the first belt 251a and the second belt 252b cannot be improved, and image failures, such as, image misalignment, gloss shortage, and white void, cannot be prevented.

By contrast, when the difference in the peripheral velocity between the nip-rollers 252 and the guide-rollers 253 is larger than 2%, the first belt 251a and the second belt 251b cannot be rotated smoothly, and the velocities of these belts 251 fluctuate, which can cause vibration.

The difference in the peripheral velocity can be adjusted by changing the gear ratio between the first nip-gear 264A driving the nip-rollers 252 and the first guide-gear 264C driving the guide-rollers 253. Therefore, this configuration can simplify the driving mechanism and facilitate the control of the driving.

FIG. 5 is a schematic diagram illustrating a configuration of an driving mechanism 260 according to a variation of the present embodiment. As shown in FIG. 5, the driving mechanism 260 includes a second-guide gear 264D, instead of the shaft bearing assembly 266. The second guide-gear 264D serves as a third gear. In the driving mechanism 260, the second-guide gear 264D that is attached to the shaft 263b of the lower second guide-roller 253b engages the gear 264C at same number of teeth.

Therefore, because the driving force is transmitted from the first guide-gear 264C to the second guide-gear 264D at the same velocity, the first guide-roller 253a and the second guide-roller 253b rotate at almost the same velocity, and tensile force of the first belt 251a and the second belt 251b can be stable. It is to be noted that, for ease of explanation and illustration, because other than the difference described above the driving mechanism 260 has a configuration similar to the configuration of the driving mechanism 26 in the first variation, other components of the driving mechanism 260 are represented by identical reference numerals and the description thereof is omitted below.

In the configurations shown in FIG. 4 and FIG. 5, because the tensile force of the first belt 251a disposed facing the image face of the sheet P can be stable, the above-described failures can be prevented or reduced.

Additionally, in the configuration shown in FIG. 5, because the tensile force of the first belt 251a and the second belt 251b can be stable, the image quality can be further improved.

Numerous additional modifications and variations are possible in light of the above teachings. It is therefore to be understood that, within the scope of the appended claims, the disclosure of this patent specification may be practiced otherwise than as specifically described herein.

What is claimed is:

1. A belt-fixing device comprising:
a first, seamless belt;
a second, seamless belt, disposed in contact with the first belt, to form a nip through which a recording medium passes;
a heating member to heat at least one of the first belt and the second belt;
a first roller disposed inside the first belt;
a second roller disposed inside the first belt, upstream from the first roller in a direction in which the recording medium is conveyed;
a third roller disposed inside the second belt, facing the first roller to cause the first belt and the second belt to press against each other at the nip; and
a fourth roller disposed inside the second belt, facing the second roller to cause the first belt and the second belt to press against each other at the nip,
the first roller and the second roller rotating at different peripheral velocities,
the third roller and the fourth roller rotating at different peripheral velocities.

2. The belt-fixing device according to claim 1, wherein the peripheral velocity of the second roller and the fourth roller is slower than that of the first roller and the third roller.

3. The belt-fixing device according to claim 2, wherein the peripheral velocity of the second roller and the forth roller is slower by 1% to 2% than the peripheral velocity of the first roller and the third roller.

4. The belt-fixing device according to claim 1, further comprising:
a driving source to generate a driving force;
a first gear to transmit the driving force from the driving source to the first roller; and
a second gear to transmit the driving force to the second roller,
wherein a gear ratio between the first gear and the second gear is different.

5. The belt-fixing device according to claim 4, wherein the driving force is transmitted from the first gear to the second gear

6. The belt-fixing device according to claim 5, further comprising a third gear to transmit the driving force to the fourth roller,
wherein the driving force is transmitted from the second gear to the third gear.

7. The belt-fixing device according to claim 1, wherein the third roller is rotated by rotation of the first roller via the first belt and the second belt.

8. The belt-fixing device according to claim 7, wherein the fourth roller is rotated by rotation of the second roller via the first belt and the second belt.

9. An image forming apparatus comprising:
an image carrier;
a charging device to charge the image carrier uniformly;
an exposure device to expose a charged surface of the image carrier and form a latent image on the image carrier;
a developing device to render visible the latent image formed on the surface of the image carrier;
a cleaning device to remove residual toner on the image carrier after development;
a transfer device to transfer the visible image onto a recording medium directly or indirectly via an intermediate transfer member; and
a belt-fixing device to fix the image on a recording medium,
the belt-fixing device comprising:
a first, seamless belt;
a second, seamless belt, disposed in contact with the first belt, to form a nip through which the recording medium passes;
a heating member to heat at least one of the first belt and the second belt;
a first roller disposed inside the first belt;
a second roller disposed inside the first endless belt, upstream from the first roller in a direction in which the recording medium is conveyed,
a third roller disposed inside the second belt, facing the first roller to cause the first belt and the second belt to press against each other at the nip; and
a fourth roller disposed inside the second belt, facing the second roller to cause the first belt and the second belt to press against each other at the nip,
the first roller and the second roller rotating at different peripheral velocities,
the third roller and the fourth roller rotating at different peripheral velocities.

10. The image forming apparatus according to claim 9, wherein, in the belt-fixing device, the peripheral velocity of the second roller and the fourth roller is slower than that of the first roller and the third roller.

11. The image forming apparatus according to claim 10, wherein the peripheral velocity of the second rollers and the forth roller is slower by 1% to 2% than the peripheral velocity of the first roller and the third roller.

12. The image forming apparatus according to claim 9, the belt-fixing device further comprising:
a driving source to generate a driving force;
a first gear to transmit the driving force from the driving source to the first roller; and
a second gear to transmit the driving force to the second roller,
wherein a gear ratio between the first gear and the second gear is different.

13. The image forming apparatus according to claim 12, wherein the driving force is transmitted from the first gear to the second gear.

14. The image forming apparatus according to claim 13, the belt-fixing device further comprising a third gear to transmit the driving force to the fourth roller,
wherein the driving force is transmitted from the second gear to the third gear.

15. The image forming apparatus according to claim 9, wherein the third roller is rotated by the first roller via the first belt and the second belt in the belt-fixing device.

16. The image forming apparatus according to claim 15, wherein the fourth roller is rotated by the second roller via the first belt and the second belt in the belt-fixing device.
